(19) United States
(12) Patent Application Publication
(10) Pub. No.: US 2011/0195695 A1
(43) Pub. Date: Aug. 11, 2011

(54) MANAGING EVENT DISTRIBUTION TO APPLICATIONS WITHIN A WIRELESS COMMUNICATIONS DEVICE

(76) Inventors: Rashim Gupta, New York, NY (US); Mark A. Lindner, Superior, CO (US); Tejaswini Gollamudi, San Diego, CA (US)

(21) Appl. No.: 12/704,385

(22) Filed: Feb. 11, 2010

(51) Int. Cl. H04W 4/06

(52) U.S. Cl. 455/414.1

(57) ABSTRACT

Aspects are directed to managing event distribution to applications within a wireless communications device. A first application of a plurality of applications installed on a platform of the wireless communications device is provisioned with a private address of an interface portion of a second application from among the plurality of applications. A registration message is received at the interface portion of the second application from the first application, the registration message requesting registration for event message distribution at the interface portion of the second application based on the provisioned private address. An event notifier portion of the second application registers the first application to receive event message distribution. Next, the event notifier portion of the second application receives an indication that an event for distribution has occurred, and the event notifier portion distributes a notification, indicating at least that an event has been detected, to each registered application.

### BACKGROUND

Aspects of the present disclosure are directed to managing event distribution to applications within a wireless communications device.

Wireless communication systems have developed through various generations, including a first-generation analog wireless phone service (1G), a second-generation (2G) digital wireless phone service (including interim 2.5G and 2.75G networks), and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communications network have been configured to be sent to a single destination or access terminal A transmission of data to a single destination is referred to as “unicast.” As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A broadcast channel can be used for push-to-talk calls using conventional signaling techniques.

The various wireless communication systems described above can be used to transmit/receive data and/or signaling to/from the access terminals. The received data/signaling can be interpreted by applications resident on the access terminal, which can lead to event messages being generated on the access terminals related to the received data/signaling.

### SUMMARY

Aspects are directed to managing event distribution to applications within a wireless communications device. A first application of a plurality of applications installed on a platform of the wireless communications device is provisioned with a private address of an interface portion of a second application from among the plurality of applications. A registration message is received at the interface portion of the second application from the first application, the registration message requesting registration for event message distribution at the interface portion of the second application based on the provisioned private address. An event notifier portion of the second application registers the first application to receive event message distribution. The event notifier portion of the second application receives an indication that an event for distribution has occurred, and the event notifier portion distributes a notification, indicating at least that an event has been detected, to each registered application.

### BRIEF DESCRIPTION OF THE DRAWINGS

A more complete appreciation of aspects of the subject disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 is a diagram of a wireless network architecture that supports access terminals and access networks in accordance with at least one aspect of the subject disclosure.

FIG. 2 illustrates the carrier network according to an example aspect of the subject disclosure.

FIG. 3 is an illustration of an access terminal in accordance with at least one aspect of the subject disclosure.

FIG. 4A illustrates software modules that may be executed upon the platform of the access terminal of FIG. 3, according to one aspect.

FIG. 4B illustrates an event distribution process, according to one aspect.

FIG. 5A illustrates software modules that may be executed upon the platform of the access terminal of FIG. 3, according to one aspect.

FIG. 5B illustrates another event distribution process, according to one aspect.

FIG. 6A illustrates software modules that may be executed upon the platform of the access terminal of FIG. 3 according to one aspect of the subject disclosure.

FIG. 6B illustrates an event distribution process according to one aspect of the subject disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external, or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein, the term traffic channel can refer to either a forward or reverse traffic channel.

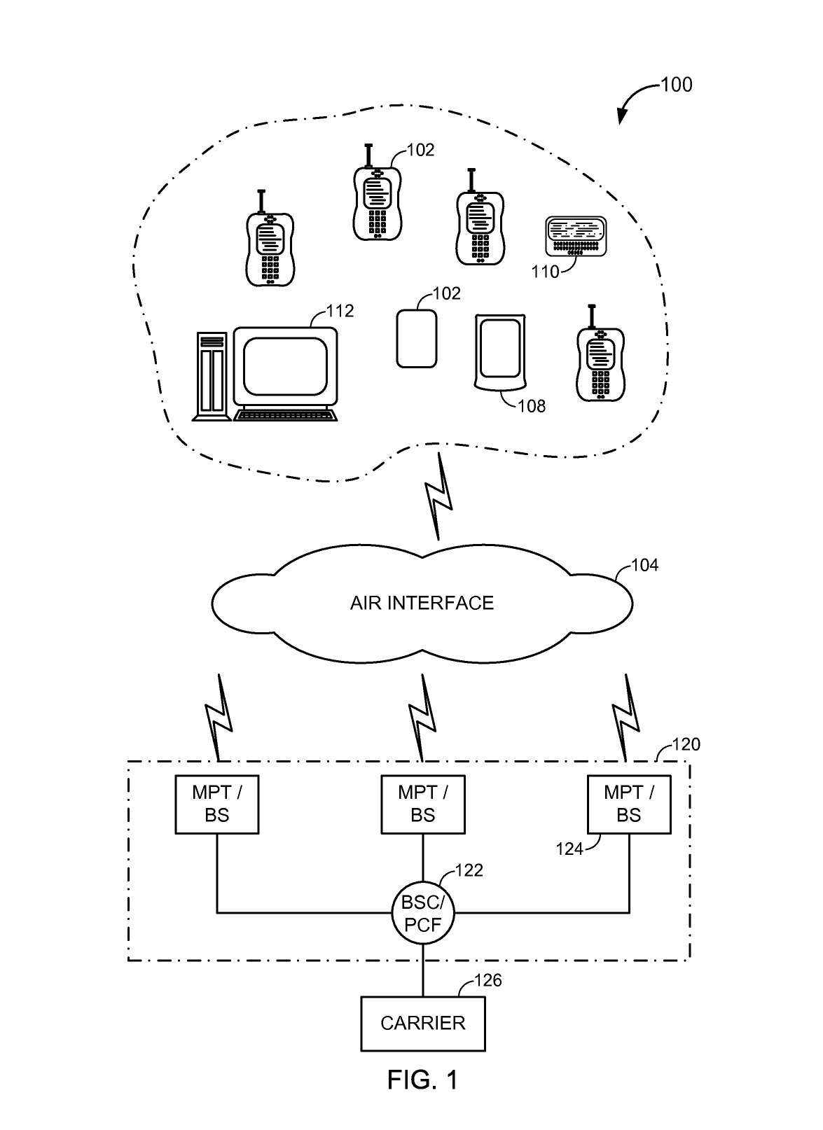

FIG. 1 illustrates a block diagram of one exemplary aspect of a wireless system 100 in accordance with at least one aspect of the disclosure. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Aspects of the disclosure can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary aspects of the disclosure are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 100 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the disclosure is not limited to the configuration illustrated. For example, in another aspect, the functionality of the BSC/PCF 122 and one or more of the MPT/BS 124 may be collapsed into a single “hybrid” module having the functionality of both the BSC/PCF 122 and the MPT/BS 124.

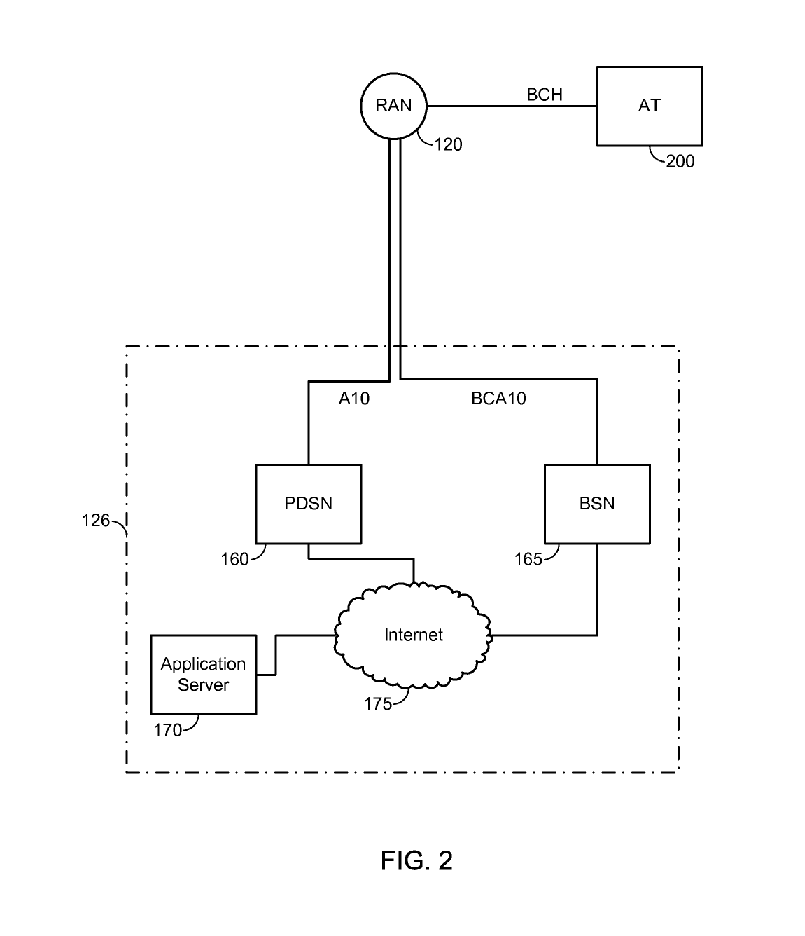

FIG. 2 illustrates the carrier network 126 according to an aspect of the present disclosure. In the aspect of FIG. 2, the carrier network 126 includes a packet data serving node (PDSN) 160, a broadcast serving node (BSN) 165, an application server 170 and an Internet 175. However, application server 170 and other components may be located outside the carrier network in alternative aspects. The PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2, the PDSN 160 may communicate with the RAN 120 (e.g., the BSC/PCF 122) via a conventional A10 connection. The A10 connection is well-known in the art and will not be described further for the sake of brevity.

Referring to FIG. 2, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

Generally, as will be described in greater detail below, the RAN 120 transmits multicast messages, received from the BSN 165 via the BCA10 connection, over a broadcast channel (BCH) of the air interface 104 to one or more access terminals 200.

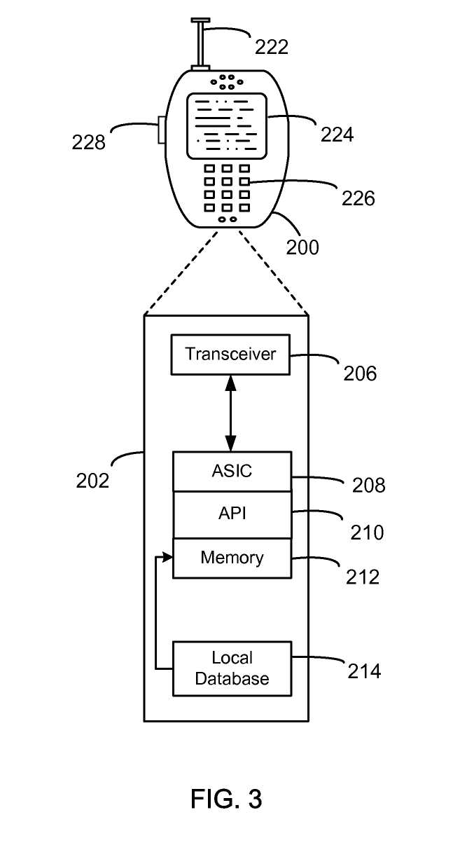

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft, or hard disk, or the like. The internal platform 202 components can also be operably coupled to external devices such as antenna 222, display 224, push-to-talk button 228, and keypad 226 among other components, as is known in the art.

Accordingly, an aspect of the disclosure can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210, and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the disclosure is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the aspects of the disclosure and are merely to aid in the description of aspects of the disclosure.

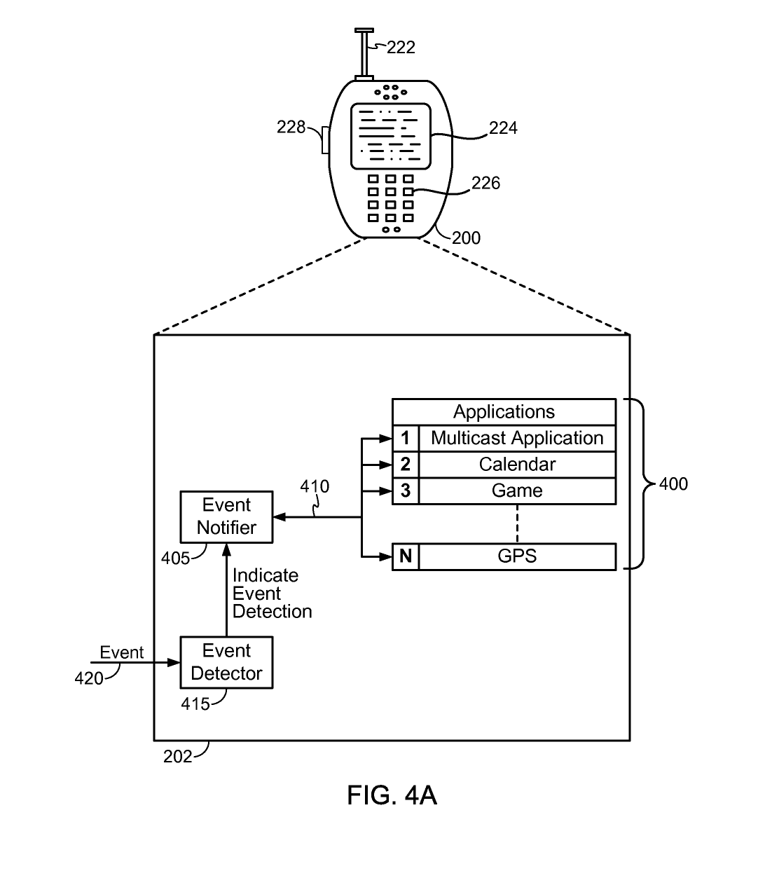

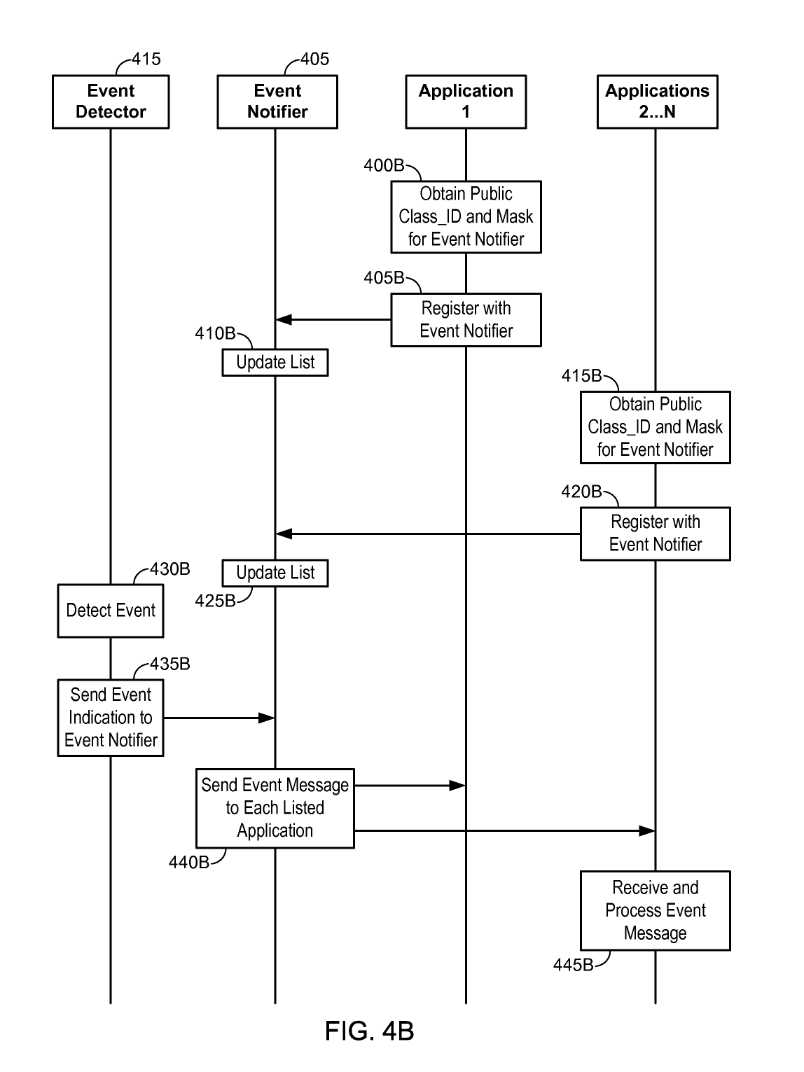

FIG. 4A illustrates software modules that may be executed upon the platform 202 of the access terminal 200 of FIG. 3. Also shown in FIG. 4A is an abstraction of the communication paths between the software modules. Accordingly, the platform 202 executes a plurality of applications 1 . . . N, 400. Each of the plurality of applications 1 . . . N has a Class_ID and mask that can collectively be used to identify, or address, an event notifier 405. The communication link 410 between the event notifier 405 and the applications 1 . . . N, 400, is illustrated in FIG. 4A as a two-way arrow because each application 400 may send information to the event notifier 405, and the event notifier 405 in turn may in turn potentially send information to each application 400. The event notifier 405 is further connected to an event detector 415, which can detect ‘events’ 420 that are typically triggered by an external stimulus. For example, a user of the access terminal 200 pushing a push-to-talk (PTT) button to initiate a PTT call may qualify as the event 420. Alternatively, an incoming call message received at the access terminal 200 via the transceiver 206 may qualify as the event 420. In an example, the event detector 415 may constitute a portion of one of the applications 1 . . . N.

In a further example, the environment within which the platform 202 executes the software modules illustrated in FIG. 4A may be compliant with an operating environment. The operating environment may correspond to an operating system such as BREW MP™ of QUALCOMM Incorporated, San Diego, or to an application execution environment such as BREW®, also of QUALCOMM Incorporated, San Diego. However, while certain references to BREW-specific features and functionality are described below, it will be readily apparent how other aspects of the disclosure can be directed to any operating environment having a similar event notification handling protocols.

In an example, in a BREW environment, the event notifier 405 corresponds to a notification class that is addressed by a Class_ID and mask pair, and the event notifier 405 can be configured to send event notifications to requesting applications. The event notifier 405, as well as any other notification modules belonging to the notification class, maintains a list of applications to which notifications are sent, and any application can register with the event notifier 405 to receive notifications so long as the Class_ID and mask of the event notifier 405 are known to the requesting application. In FIG. 4A, the Class_ID, and mask of the event notifier 405 is publicly-available or advertised, and as such any of applications 1 . . . N may register with the event notifier 405.

An event distribution process executed by the software modules illustrated in FIG. 4A will now be described in more detail with respect to FIG. 4B. Referring to FIG. 4B, in 400B, application 1 (e.g., a multicast application such as a QChat client) obtains a publicly-available address (e.g., Class_ID and mask) for the event notifier 405. For example, as noted above, the Class_ID and mask for the event notifier 405 can be publicly advertised and disseminated to each of applications 1 . . . N. In 405B, Application 1 registers with the event notifier 405 by sending a request to receive event notifications. The registration request of 405B may be addressed to the Class_ID and mask for the event notifier 405, and may indicate how the event notifier 405 can pass event notifications to application 1, such as a return address or Class_ID of application 1. In a BREW environment, in an example, the registration request of 405B may correspond to an API such as ISHELL_RegisterNotify(oxffE, 0x01), where the Class_ID of the event notifier 405 corresponds to oxffE, and the mask of the event notifier 405 corresponds to 0x01.

Upon receiving the registration message, the event notifier 405 updates a list of applications to which event messages are to be sent, 410B. For example, the list maintained by the event notifier 405 may correspond to a set of Class_IDs of applications that have registered with the event notifier 405, such as application 1 in 405B and 410B. Next, one or more of applications 2 . . . N also obtains the public Class_ID and mask for the event notifier 405, 415B, and register with the event notifier 405, 420B. In response to the registration(s) received at 420B, the event notifier 405 again updates the list, 425B.

At some later point in time, assume that the event detector 415 detects an event (e.g., an incoming call, a floor release message for a group call, etc.), 430B. The event detector 415 sends an indication that an event has occurred to the event notifier 405, 435B. The event notifier 405 then generates and sends an event message that passes event information to each listed application, 440B. For example, in a BREW environment, the event message may correspond to an API denoted as IShell_NOTIFY(oxFFE, 0x01), which the BREW operating environment maps to applications 1 . . . N for broadcasting the event via an EVT_NOTIFY trigger. Each application among applications 1 . . . N that receives the event message then processes the received event message, 445B.

Alternatively, instead of generating the event message that includes actual information related to a particular event in 440B, the event notifier 405 may first generate and send a signal, which does not include actual event data, to each listed application. This signal functions to notify each listed application that a new event has been detected without actually indicating information related to the event. Thereafter, it is the responsibility of each listed application to send an event retrieval request to the event notifier 405, which will then respond with the event message, 440B. Thus, while FIG. 4B illustrates that the event message is sent to each listed application in 400B, it will be appreciated that the sending of the event message may be automatic upon receipt of the event indication from the event detector 415, or alternatively can be performed in response to separate event retrieval requests received at the event notifier 405 from each listed application.

As will be appreciated by one of ordinary skill in the art, because the Class_ID and mask of the event notifier 405 are publicly-available to each of applications 1 . . . N, and the notification class is configured to permit any requesting application to receive notifications, it is difficult to restrict event messages to a limited subset of applications among applications 1 . . . N. For example, the process illustrated in FIG. 4B would not necessarily be capable of ensuring that applications 1 . . . 3 can register with the event notifier 405, but that applications 4 . . . N cannot register with the event notifier 405.

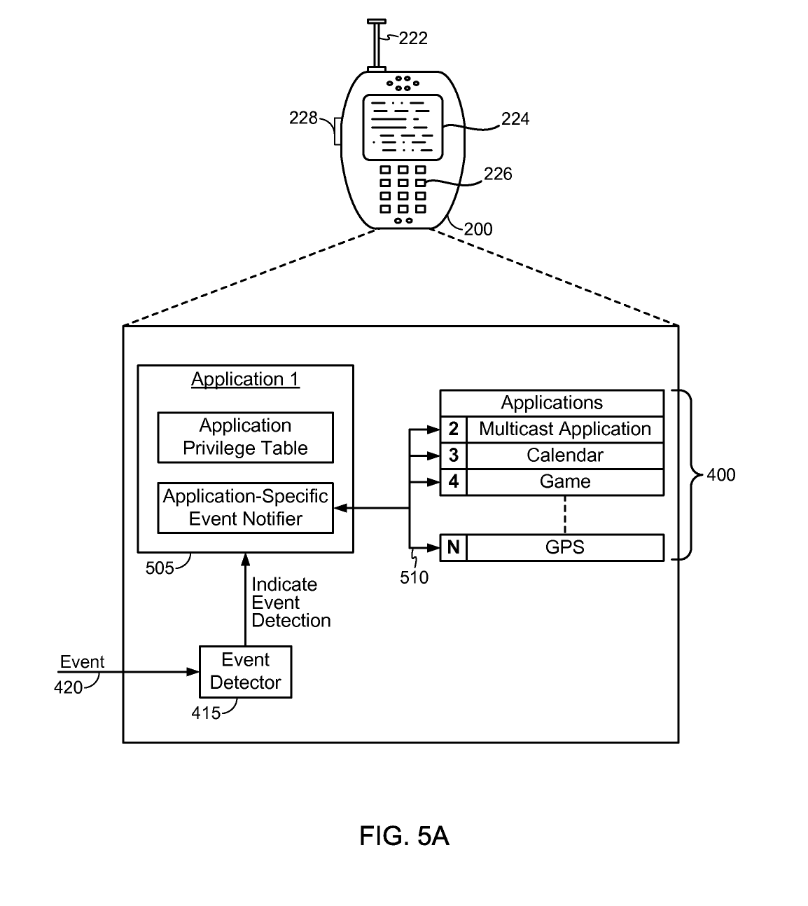

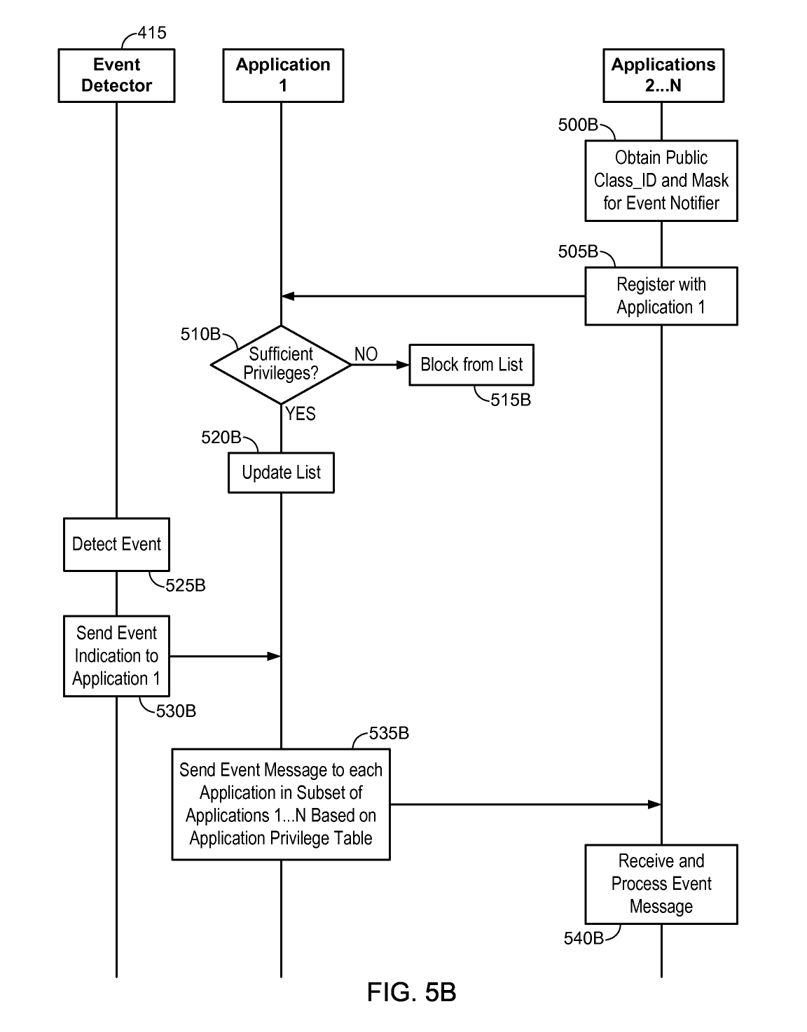

Accordingly, FIGS. 5A-5B illustrate a manner by which event messages can selectively be restricted to or from certain applications among applications 1 . . . N within an operating environment such as BREW. Accordingly, FIG. 5A illustrates software modules that may be executed upon the platform 202 of the access terminal 200 of FIG. 3. FIG. 5A is similar to FIG. 4A in certain respects, although the event notifier 405 that operates in accordance with the notification class defined above has been replaced with application 1 in FIG. 5A. Accordingly, application 1 in FIG. 5A handles its own event message distribution instead of using the notification class. As such, application 1 includes an application-specific event notifier that does not correspond to the notification class, and an application privilege table that will be discussed below in more detail with respect to FIG. 5B. Also, the communication link 410 connecting the event notifier 405 with applications 1 . . . N in FIG. 4A has been replaced with a communication link 510 connecting application 1 with applications 2 . . . N in FIG. 5A.

Referring to FIG. 5B, in 500B, assume that the Class_ID and mask for application 1 is publicly advertised to each of applications 2 . . . N. Accordingly, in 505B, one or more of applications 2 . . . N send registration request(s) to application 1 including the requesting applications' own Class_ID. For example, in a BREW® environment, if application 1 is a QChat® Development Kit (QDK) application, the registration request(s) of 505B may correspond to IQDKCOMMON_INIT('Requesting Application's Class_ID') message(s) (e.g., IQDKCOMMON_INIT is a wrapper around IShell_RegNotify in that IQDKCOMMON_INIT does more than just register for events, and IQDKCOMMON_INIT in turn invokes the IShell_RegNotify). Upon receiving the registration request, application 1 evaluates the Class_ID to determine if the requesting applications have sufficient privileges for event message registration, 510B. In particular, application 1 compares the Class_ID of each requesting application with an application privilege table, which may be configured as follows:

Example of Application Privilege Table

| Application No. | Sufficient Privileges? |
|---|---|
| 2 | Yes |
| 3 | No |
| 4 | Yes |
| . . . | |
| N | No |

Accordingly, if the application privilege table is configured as in the example above, registration requests from applications 2 and 4 would be granted, whereas registration requests from applications 3 and N would be denied, and so on. Accordingly, applications lacking sufficient privileges for event message registration are blocked from receiving messages in 515B, whereas applications having sufficient privileges are added to a list of applications to receive event messages in 520B. In an example, the application privilege table may be customizable by the OEM/Carrier. Thus, the OEM could add software that enabled over-the-air updates from the Carrier Provisioning System to dynamically modify this table. In an alternative example, the application privilege table may correspond to a static table compiled in at runtime, such that the permissions in the application privilege table do not necessarily change during run-time.

At some later point in time, assume that the event detector 415 detects an event (e.g., an incoming call, a floor release message for a group call, etc.), 525B. The event detector 415 sends an indication that an event has occurred to application 1, 530B. The application-specific event notifier 405 then generates and sends an event message to each listed application, 535B. For example, in a BREW® environment, the message of 650B may correspond to an ISHELL_SENDEVENT(‘Class_ID of Application 2’) message. Alternatively, similar to 440B of FIG. 4, the application-specific event notifier 405 may first signal to applications 2 . . . N that a new event is available without indicating information related to the particular event, and can wait for one or more of applications 2 . . . N to send an event retrieval request before distributing the event-specific information. Also, while not shown explicitly in the example application privilege table above, it will be appreciated that the applications to which either the signal or event message are sent corresponds to applications that have sufficient privileges to receive event messaging that have also registered to receive event messages. Thus, merely having sufficient privileges to receive event information may not mean that event messages are sent to a particular application unless that application is also registered. As will be appreciated, the listed applications corresponds to a subset of the applications 1 . . . N because less than all of applications 1 . . . N may have sufficient privileges to be on the list based on the application privilege table, and less than all of the applications with sufficient privileges may have registered to receive event notifications. Each application among applications 1 . . . N that receives the event message then processes the received event message, 540B.

As will be appreciated in view of the remarks above, the event notifier 405 configured as in FIG. 4A that operates in accordance with the process of FIG. 4B can be contacted by any of applications 1 . . . N because its Class_ID and mask are public, and the notification class to which the event notifier 405 belongs is not configured to restrict registrations. Alternatively, to obtain more control regarding application-restriction for event message distribution, a customized or application-specific event notifier (e.g., that does not belong to the notification class supported natively by the BREW environment) can be used as illustrated in FIGS. 5A and 5B. However, in this case, the application that distributes the event messages is required to maintain a table indicating which applications are permitted to receive event messages, and which applications are not permitted to receive event messages. Maintaining the application privilege table with up to date information can be difficult as platforms 202 on different mobile communication devices can be configured with many different applications. Thus, having each application store a large mapping table with privilege associations can complicate the implementation the platform 202, with the complexity scaling with the number of applications on the platform.

Accordingly, aspects of the disclosure are directed to restricting which applications can receive event messages while also taking advantage of the notification class. The aspects can be implemented in a BREW environment, or in any other operating environment having a similarly configured notification class for distributing event notifications.

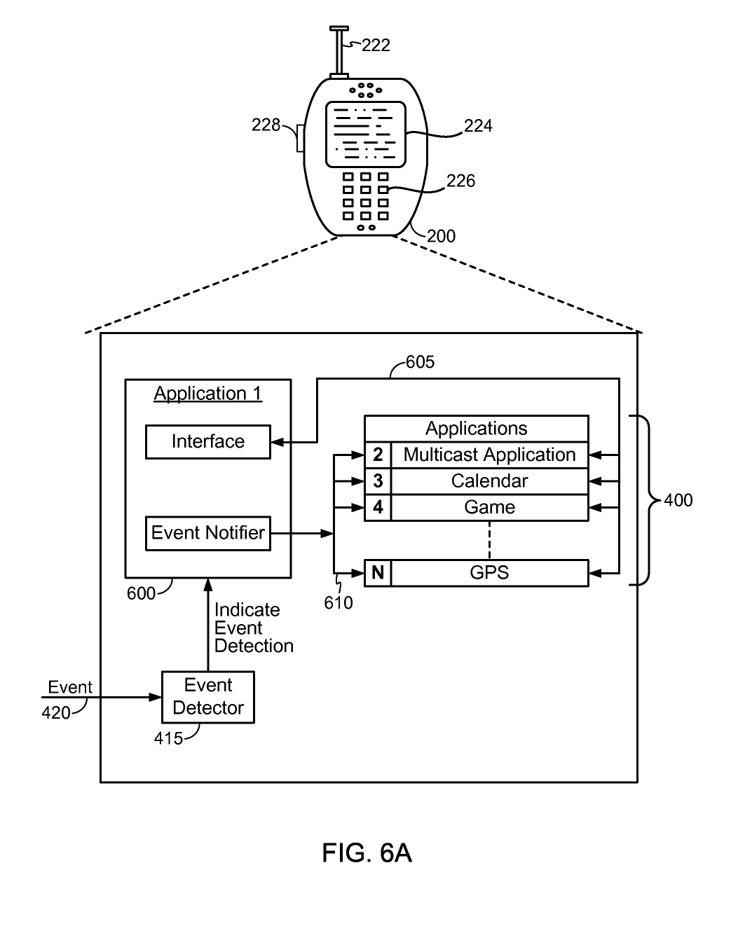

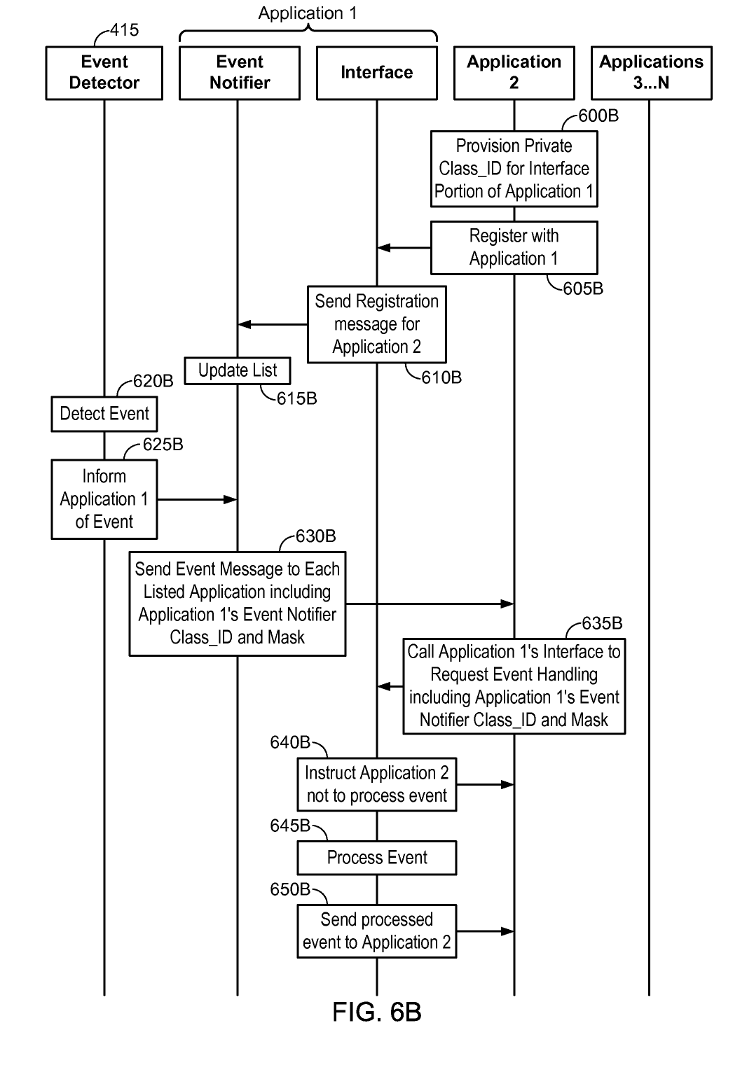

Accordingly, FIG. 6A illustrates software modules that may be executed upon the platform 202 of the access terminal 200 of FIG. 3. The platform 202 of FIG. 6A includes applications 2 . . . N, 400, as in FIG. 5A, and the event detector 415 that receives the event 420. The event detector 415 indicates an event detection to application 1, 600. In FIG. 6A, application 1 (e.g., a multicast application, such as a QChat client) includes a ‘private’ interface portion to one or more of applications 2 . . . N, and a ‘secret’ event notifier portion. The interface is private in the sense that the Class-ID and mask for addressing the interface portion are not advertised to all of applications 2 . . . N, but applications among applications 2 . . . N that have sufficient privileges for receiving event messages from application 1 are provisioned, in advance, with the private Class_ID and mask for the interface portion. The interface portion is two-way or bi-directional, and while messages addressed to the interface portion of application 1 are restricted to applications that are aware of the Class-ID and mask for the interface portion of application 1, messages addressed to applications 2 . . . N from the interface of application 1 may be based on either private or public Class_IDs.

Application 1's event notifier portion, on the other hand, has a secret Class_ID and mask that are known only internally to application 1. Thus, the interface portion of application 1 has access to the Class_ID and mask for the event notifier portion of application 1, but applications 2 . . . N are not aware of the Class_ID and mask for application 1's event notifier portion. Thus, any information from applications 2 . . . N intended for the event notifier portion of application 1 is mediated by the interface portion. Thus, as noted above, because applications among applications 2 . . . N that are provisioned with the Class_ID and mask for the interface portion of application 1 can send or receive information to/from the interface portion, communication link 605 is illustrated as a two-way interface. Likewise, because applications 2 . . . N do not send information to the event notifier portion of application 1 directly, the communication link 610 is illustrated as a one-way communication link. As will be appreciated in view of the description of FIG. 6B below, the event notifier portion of the application 1 can be configured in accordance with the notification class (e.g., in a BREW environment), such that any registration requests for event messages are granted, while also restricting access to event messages to a desired group of applications without the maintenance burdens associated with an application privilege table.

Referring to FIG. 6B, in 600B, application 2 is provisioned with a private Class_ID and mask for application 1's interface portion. For example, the provisioning of 600B can occur when application 2 is added or installed into the platform 202. In an alternative example, the provisioning of 600B can occur at power up, or at least before application 2 (e.g., the multicast application) registers. However, application 2 (e.g., the multicast application) can also take itself offline and then trigger a provisioning update in 600B. Generally, a carrier would want to update the application privilege table via provisioning system when an application is installed, or even prior to the installation. However, it will be appreciated that an entry for an application to the application privilege table prior to the application being installed, then once its installed, the notifier already knows the privilege status for the now-installed application. Conversely, the application can be installed without a privilege entry in the application privilege table entry, and this application would not get event notification updates until the application updates the provisioning for the notifier, and also registers. It will be appreciated that different implementations can be achieved in accordance with the preferences of the carrier/OEM controlling the application. In FIG. 6B, assume that only application 2 is provisioned with the private Class_ID and mask for interfacing with application 1, and that applications 3 . . . N are not so provisioned.

Next, application 2 sends a registration request (e.g., in response to a ping from the application 1, not shown, which can be sent to each of applications 2 . . . N) to the interface portion of application 1 that is addressed to the provisioned private Class_ID and mask from 600B. Application 1 receives the registration request at its two-way interface portion, and the two-way interface portion then generates an internal registration message that includes application 2's Class_ID and sends the internal registration message to application 1's event notifier portion, 610B. The event notifier portion then adds application 2 to its list of applications that receive event messages, 615B.

At some later point in time, assume that the event detector 415 detects an event (e.g., an incoming call, a floor release message for a group call, etc.), 620B. The event detector 415 sends an indication that an event has occurred to application 1, 625B. The event notifier portion of application 1 then generates and sends an event message that passes event information to each listed application from 615B, 630B. Alternatively, similar to 440B of FIG. 4, the event notifier portion of application 1 may first signal to each listed application that a new event is available without indicating information related to the particular event, and can wait for one or more of the notified applications to send an event retrieval request before distributing the event-specific information. As will be appreciated, the listed applications correspond to a subset of the applications 1 . . . N because less than all of applications 1 . . . N may have been provisioned with the private Class_ID and mask for the two-way interface portion of application 1. The event message of 630B includes the secret Class ID and mask of application 1's event notifier portion. However, application 2 is not actually aware of the secret Class ID and mask within the event message, and this data portion of the event message is instead used as a ‘cookie’ for later messaging by application 2. In other words, application 2 cannot actually use the secret Class_ID and mask in the message of 630B to contact the event notifier portion of application 1 directly.

Upon receiving the event message in 630B, instead of processing the event message, application 2 sends a request to the two-way interface for application 1 to handle the event, 635B. For example, in a BREW environment, the handle-event message of 635B may correspond to an IQDKCOMMON_HANDLEEVENT( ) API. Further, the handle-event message of 635B includes the secret Class_ID and mask, or ‘cookie’, of the event notifier portion of application 1. The handle-event message of 635B including this cookie triggers a recognition at the two-way interface for application 1 to process the event. In 640B, after receiving the handle-event message of 635B, the two-way interface of application 1 sends a message instructing application 2 not to process the event until further notice. Application 1 then proceeds to process the event, 645B. After application 1 processes the event in 645B, the processed event is then sent to application 2 via the two-way interface, 650B. For example, in a BREW environment, the message of 650B may correspond to an ISHELL_SENDEVENT(‘Class_ID of Application 2’) message.

In an example, one reason that blocks 630B through 650B show the processing of the event message occurring at application 1 instead of application 2 is so the code associated with the event message can be executed in application 1's context. Thus, the simplest way to achieve this is to send the event to application 1 for processing. Once application 1 receives the event in 635B, the context of the event message's processing switches to application 1 during 645B. It will be appreciated that 635B through 650B can, in some instances, be optional and need not be included in each aspect of the disclosure. For example, 635B through 650B can be optional if the Class_ID present for the event does not match the Class_ID of application 1. Also, it will be appreciated that if 635B through 650B are optional and are omitted from FIG. 6B in at least one implementation, the processing of the event may thereby occur at application 2 instead of application 1.

In an example, with respect to FIGS. 6A and 6B, the platform 202 may be configured to operate as a BREW environment. Further, application 1 may correspond to a QChat client within the BREW environment, and application 2 may correspond to an application that is somehow related to the QChat client. For example, application 2 may correspond to a QChat Development Kit (QDK) application, which may in turn interface with other of applications 3 . . . N.

While aspects of the disclosure described above generally handle addressing applications or application portions based on a Class_ID and/or an associated mask, it will be appreciated that other addressing schemes are possible in other aspects of the disclosure. Thus, instead of provisioning application 2 with a private Class_ID and mask in 600B of FIG. 6B, any private address for the interface portion of application 1 can be provisioned instead. Likewise, the ‘secret’ Class_ID and mask of the event notifier portion of application 1 in FIG. 6A-6B may likewise correspond to any type of address, and not necessarily a Class_ID and mask pair. Thus, in the above-aspects, Class_ID is used as the means in which an application can be located. Other examples of addressing information that can permit an application to be located or identified include a mime-type, AppName, etc. Accordingly, in other operating environment, the Class_ID can be exchanged with another type or types of application identifiers associated with the other operation systems, as will be appreciated by one of ordinary skill in the art.

In the aspects of the disclosure provided above, while the term “multicast” has been used to refer to certain types of communication sessions and signaling messages, this term has been used to correspond to any type of group call, and is not necessarily restricted to IP multicasting implementations of group calls. For example, a call between more than two ATs that communicate via unicast protocols can also be construed as a multicast call in other aspects of the disclosure. Thus, a multicast or group call can be achieved either with IP multicasting protocols, or alternatively with multiple IP unicast sessions.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

While the foregoing disclosure shows illustrative aspects, it should be noted that various changes and modifications could be made herein without departing from the scope of the disclosure as defined by the appended claims. The functions, steps, and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of managing event distribution to applications within a wireless communications device, comprising:
provisioning at least a first application of a plurality of applications installed on a platform of the wireless communications device with a private address of an interface portion of a second application from among the plurality of applications;
receiving, from the first application, a registration message requesting registration for event message distribution at the interface portion of the second application based on the provisioned private address;
registering the first application to receive event message distribution at an event notifier portion of the second application;
receiving an indication that an event for distribution has occurred; and
distributing a notification, indicating at least that an event has been detected, to each registered application.

2. The method of claim 1, wherein the registering includes:
generating an internal registration message within the second application for registering the first application for event message distribution, the internal registration message being addressed to the event notifier portion of the second application whose address is only known to the second application among the plurality of applications, and
registering the first application at the event notifier portion of the second application to receive event message distribution based on the internal registration message.

3. The method of claim 1, wherein the distributing includes:
distributing, to each registered application, a notification that an event has been detected without passing event-specific information;
receiving, from at least one registered application, an event retrieval request that requests the event-specific information; and
distributing the event-specific information to each application from which the event retrieval request is received.

4. The method of claim 3, further comprising:
receiving a request, from at least one of the registered applications from which the event retrieval request is received, to handle the event at the second application;
processing the event at the second application; and
sending the processed event to the at least one registered application.

5. The method of claim 1, wherein the distributing includes:
distributing, to each registered application, a notification that an event has been detected along with event-specific information for the event.

6. The method of claim 5, further comprising:
receiving a request from at least one registered application to handle the event at the second application;
processing the event at the second application; and
sending the processed event to the at least one registered application.

7. The method of claim 6, further comprising:
sending, in response to the received request from the at least one registered application to handle the event at the second application, a message to the first application instructing the first application not to handle the event.

8. The method of claim 1, wherein the first application corresponds to a multicast application.

9. The method of claim 1, wherein the plurality of applications that are provisioned with the private address of the interface portion of the second application correspond to applications that the second application expects to have sufficient privileges to receive event notifications.

10. The method of claim 9, wherein the privilege expectation for the plurality of applications is based upon an application privilege table maintained by the second application.

11. The method of claim 10, wherein the distributing distributes the notification to applications that have sufficient privileges based on the application privilege table and applications that have registered for event message distribution with the event notifier portion of the second application.

12. The method of claim 9, wherein at least one application is not provisioned with the private address of the interface portion of the second application and the at least one application is not included among the plurality of applications, and
wherein the second application does not expect the at least one application to have sufficient privileges to receive event notifications.

13. The method of claim 1, wherein the provisioning occurs once (i) the first application is installed on the wireless communications device, and (ii) an application privilege table indicates the first application to have sufficient privileges to receive event notifications.

14. The method of claim 13, wherein the provisioning occurs when the first application is installed on the wireless communications device if the application privilege table indicates the first application as having sufficient privileges to receive event notifications at or before the installation.

15. The method of claim 13, wherein the provisioning occurs after the first application is installed on the wireless communications device if the application privilege table does not indicate the first application as having sufficient privileges to receive event notifications at or before the installation.

16. The method of claim 13, wherein, if (i) and (ii) are satisfied, the provisioning occurs upon power-up of the wireless communications device.

17. A wireless communications device within a wireless communications system, the wireless communications device configured to manage a distribution of events to applications installed thereon, comprising:
means for provisioning at least a first application of a plurality of applications installed on a platform of the wireless communications device with a private address of an interface portion of a second application from among the plurality of applications;
means for receiving, from the first application, a registration message requesting registration for event message distribution at the interface portion of the second application based on the provisioned private address;
means for registering the first application to receive event message distribution at an event notifier portion of the second application;
means for receiving an indication that an event for distribution has occurred; and
means for distributing a notification, indicating at least that an event has been detected, to each registered application.

18. The wireless communications device of claim 17, wherein the means for registering includes:
means for generating an internal registration message within the second application for registering the first application for event message distribution, the internal registration message being addressed to the event notifier portion of the second application whose address is only known to the second application among the plurality of applications, and
means for registering the first application at the event notifier portion of the second application to receive event message distribution based on the internal registration message.

19. The wireless communications device of claim 17, wherein the means for distributing includes:
means for distributing, to each registered application, a notification that an event has been detected without passing event-specific information;
means for receiving, from at least one registered application, an event retrieval request that requests the event-specific information; and
means for distributing the event-specific information to each application from which the event retrieval request is received.

20. The wireless communications device of claim 17, wherein the means for distributing includes:
means for distributing, to each registered application, a notification that an event has been detected along with event-specific information for the event.

21. A wireless communications device within a wireless communications system, the wireless communications device configured to manage a distribution of events to applications installed thereon, comprising:
logic configured to provision at least a first application of a plurality of applications installed on a platform of the wireless communications device with a private address of an interface portion of a second application from among the plurality of applications;
logic configured to receive, from the first application, a registration message requesting registration for event message distribution at the interface portion of the second application based on the provisioned private address;
logic configured to register the first application to receive event message distribution at an event notifier portion of the second application;
logic configured to receive an indication that an event for distribution has occurred; and
logic configured to distribute a notification, indicating at least that an event has been detected, to each registered application.

22. The wireless communications device of claim 21, wherein the logic configured to register includes:
logic configured to generate an internal registration message within the second application for registering the first application for event message distribution, the internal registration message being addressed to the event notifier portion of the second application whose address is only known to the second application among the plurality of applications, and logic configured to register the first application at the event notifier portion of the second application to receive event message distribution based on the internal registration message.

23. The wireless communications device of claim 21, wherein the logic configured to distribute includes:
logic configured to distribute, to each registered application, a notification that an event has been detected without passing event-specific information;
logic configured to receive, from at least one registered application, an event retrieval request that requests the event-specific information; and
logic configured to distribute the event-specific information to each application from which the event retrieval request is received.

24. The wireless communications device of claim 21, wherein the logic configured to distribute includes:
logic configured to distribute, to each registered application, a notification that an event has been detected along with event-specific information for the event.

25. A computer-readable storage medium comprising instructions, which, when executed by a wireless communications device within a wireless communications system where the wireless communications device is configured to manage a distribution of events to applications installed thereon, cause the wireless communications device to perform operations, the instructions comprising:
program code to provision at least a first application of a plurality of applications installed on a platform of the wireless communications device with a private address of an interface portion of a second application from among the plurality of applications;
program code to receive, from the first application, a registration message requesting registration for event message distribution at the interface portion of the second application based on the provisioned private address;
program code to register the first application to receive event message distribution at an event notifier portion of the second application;
program code to receive an indication that an event for distribution has occurred; and
program code to distribute a notification, indicating at least that an event has been detected, to each registered application.

26. The computer-readable storage medium of claim 25, wherein the program code to register includes:
program code to generate an internal registration message within the second application for registering the first application for event message distribution, the internal registration message being addressed to the event notifier portion of the second application whose address is only known to the second application among the plurality of applications, and
program code to register the first application at the event notifier portion of the second application to receive event message distribution based on the internal registration message.

27. The computer-readable storage medium of claim 25, wherein the program code to distribute includes:
program code to distribute, to each registered application, a notification that an event has been detected without passing event-specific information;
program code to receive, from at least one registered application, an event retrieval request that requests the event-specific information; and
program code to distribute the event-specific information to each application from which the event retrieval request is received.

28. The computer-readable storage medium of claim 25, wherein the program code to distribute includes:
program code to distribute, to each registered application, a notification that an event has been detected along with event-specific information for the event.

29. A wireless communications device comprising:
a memory; and
at least one processor operatively coupled to the memory including executable code for the at least one processor to manage a distribution of events to applications installed thereon, the at least one processor being configured to:
provision at least a first application of a plurality of applications installed on a platform of the wireless communications device with a private address of an interface portion of a second application from among the plurality of applications;
receive, from the first application, a registration message requesting registration for event message distribution at the interface portion of the second application based on the provisioned private address;
register the first application to receive event message distribution at an event notifier portion of the second application;
receive an indication that an event for distribution has occurred; and
distribute a notification, indicating at least that an event has been detected, to each registered application.
